(19) United States
(12) Patent Application Publication
(10) Pub. No.: US 2026/0322664 A1
(43) Pub. Date: Oct. 15, 2026

(54) RECEIVING DEVICE, EQUALIZER MODULE AND SIGNAL PROCESSING METHOD

(71) Applicant: AIONCHIP TECHNOLOGIES CO., LTD., Keelung City (TW)

(72) Inventors: Yu Chu CHEN, Keelung City (TW); Cheng-Hung WU, Keelung City (TW); Hsun Wei KAO, Keelung City (TW); Yen-Chung CHEN, Keelung City (TW)

(21) Appl. No.: 19/415,660

(22) Filed: Dec. 10, 2025

(30) Foreign Application Priority Data
Apr. 11, 2025 (TW) 114113733

(51) Int. Cl. H04L 27/04; H04L 25/49; H04L 27/06; H04L 27/08

(52) U.S. Cl. CPC H04L 27/04; H04L 25/4917; H04L 27/06; H04L 27/08

(57) ABSTRACT

The present disclosure provides a receiving device comprising: an equalizer configured to encode a signal sample of multi-level PAM into an intermediate mapping symbol, wherein the LSB of the intermediate mapping symbol represents a sign, and at least one MSB of the intermediate mapping symbol represents an absolute value of signal amplitude; and a demapper configured to demap the intermediate mapping symbol and output a restored coding symbol.

### FIELD OF INVENTION

The disclosure relates to a receiving device, an equalizer module, and a signal processing method.

### BACKGROUND

Electronic transmission systems can be used in wired or wireless communication systems, which include a transmitter, a receiver, and a communication channel. The signals transmitted by the transmitter are received by the receiver through the communication channel. However, the characteristics of the communication channel can affect the quality of signal transmission. To compensate for the affection of the communication channel, the receiver can be equipped with an equalizer, such as a decision feedback equalizer (DFE) in the receiver of a serializer/deserializer (SerDes). However, for high-speed transmission applications, such as multi-level pulse amplitude modulation (PAM) signals, the receiver's circuitry must need more area for layout of the equalizer and related processing circuits to maintain signal transmission quality.

### SUMMARY

The present disclosure provides a receiving device, which includes: an equalizer configured to encode a signal sample of multi-level PAM (pulse amplitude modulation) into an intermediate mapping symbol, wherein the LSB (Least Significant Bit) of the intermediate mapping symbol represents a sign, and at least one MSB (Most Significant Bit) represents an absolute value of the signal amplitude; and a demapper configured to demap the intermediate mapping symbol to output a restored coding symbol.

The present disclosure provides a signal processing method, which includes: encoding a signal sample of multi-level PAM into an intermediate mapping symbol, wherein the LSB of the intermediate mapping symbol represents a sign, and at least one MSB represents an absolute value of the signal amplitude; and demapping the intermediate mapping symbol to output a restored coding symbol.

The present disclosure provides an equalizer module, which includes: a plurality of slicers, configured to encode a signal sample of multi-level PAM into an intermediate mapping symbol, wherein the LSB of the intermediate mapping symbol represents a sign, and at least one MSB represents an absolute value of the signal amplitude; and a demapper, configured to demap the intermediate mapping symbol to output a restored coding symbol.

In some embodiments, the multi-level PAM is four-level PAM (PAM4). In some embodiments, the intermediate mapping symbol is 11 when the potential of the signal sample is greater than a first threshold; the intermediate mapping symbol is 01 when the potential of the signal sample is greater than a second threshold and less than the first threshold; the intermediate mapping symbol is 00 when the potential of the signal sample is greater than a third threshold and less than the second threshold; and the intermediate mapping symbol is 10 when the potential of the signal sample is less than the third threshold. In some embodiments, the demapping includes: outputting the restored coding symbol as 11 when the intermediate mapping symbol is 11; outputting the restored coding symbol as 10 when the intermediate mapping symbol is 01; outputting the restored coding symbol as 01 when the intermediate mapping symbol is 00; and outputting the restored coding symbol as 00 when the intermediate mapping symbol is 10. In some embodiments, the LSB of the intermediate mapping symbol is 1 when the potential of the signal sample is greater than a middle reference value; and the LSB of the intermediate mapping symbol is 0 when the potential of the signal sample is less than the middle reference value. In some embodiments, the at least one MSB of the intermediate mapping symbol represents the absolute value of the potential of the signal sample with respect to the middle reference value.

In some embodiments, the equalizer is a decision feedback equalizer (DFE), and the receiving device further includes: a continuous time linear equalizer (CTLE) coupled to the DFE; a deserializer configured to deserialize the restored coding symbol; and a clock data recovery circuit coupled to the DFE, the demapper, and the deserializer.

In some embodiments, the encoding is performed using a decision feedback equalizer (DFE). In some embodiments, the signal processing method further includes: using a continuous time linear equalizer (CTLE) on the signal sample of multi-level PAM; and deserializing the restored coding symbol.

### BRIEF DESCRIPTION OF DRAWINGS

In order to sufficiently understand the essence, advantages and the preferred embodiments of the present disclosure, the following detailed description will be more clearly understood by referring to the accompanying drawings.

FIG. 1 shows a block diagram illustrating a SerDes communication system according to some embodiments.

FIG. 2 shows a block diagram illustrating a DFE according to some embodiments.

FIG. 3 shows a signal eye diagram illustrating the signal samples and encoding of PAM4 according to some embodiments.

FIG. 4 shows a table illustrating the lookup table for demapping according to some embodiments.

FIGS. 5A to 5C show schematic diagrams illustrating the decision-making of the data slicers according to some embodiments.

FIG. 5D shows a schematic diagram illustrating the potential mapping relation between reference to DL and reference to DH according to some embodiments.

### DETAILED DESCRIPTION

The following description shows the preferred embodiments of the present disclosure. The present disclosure is described below by referring to the embodiments and the figures. Thus, the present disclosure is not intended to be limited to the shown embodiments, but is to be accorded with the principles disclosed herein. Furthermore, that various modifications or changes in light thereof will be suggested to persons skilled in the art and are to be included within the spirit and purview of this application and scope of the appended claims.

The embodiments of this disclosure can be applied in serializer/deserializer (SerDes) architecture. SerDes is a pair of functional blocks commonly used in high-speed communication to provide data transmission, converting data between parallel interfaces and serial interfaces.

The characteristics of the communication channel in high-speed communication can affect the quality of signal transmission. Signal distortion would cause inter-symbol interference (ISI) and reduce signal transmission quality, for example, increasing the bit error rate (BER). The receiving device in the SerDes architecture can include an equalizer to compensate for the affection of the communication channel. The transmitting device in the SerDes architecture can also include an equalizer to prevent the receiving device from making incorrect judgments or being unable to make judgments when receiving a damaged signal.

A decision feedback equalizer (DFE) is an equalizer applied in the receiving device of the SerDes architecture to compensate for ISI. DFE is used for post-cursor ISI correction and does not enhance noise during the process, thus not having the drawback of error amplification.

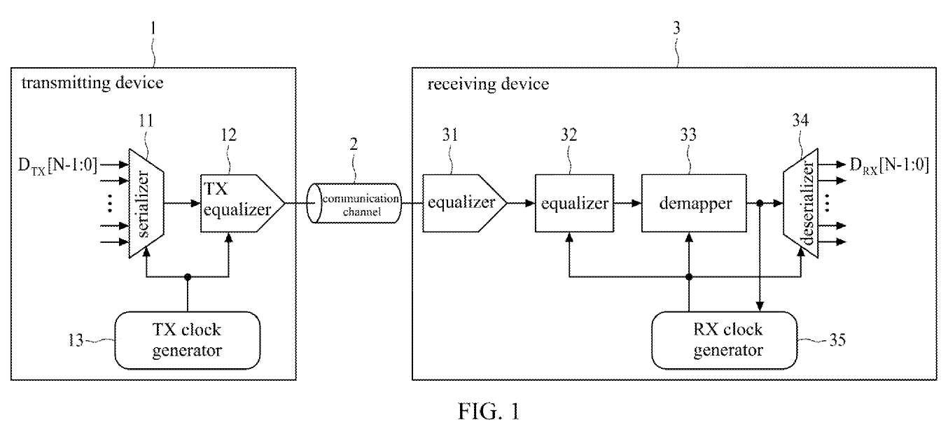

FIG. 1 shows a block diagram illustrating a SerDes communication system according to some embodiments. In the SerDes communication system in FIG. 1, a transmitting device 1 is communicatively coupled to a receiving device 3 through a communication channel 2. The transmitting device 1 is configured to send one or more signals to the receiving device 3 through the communication channel 2. The receiving device 3 may include one or more FIR filters for adjusting the data before transmitting them to the communication channel 2. The communication channel 2 can be a physical transmission medium, such as fiber optics, cables, or wires, or it can include a wireless channel, such as an RF (radio frequency) channel, etc.

The transmitting device 1 includes a serializer 11, a transmitter-side (TX) equalizer 12, and a TX clock generator 13. The TX clock generator 13 provides a clock signal to the serializer 11 and the TX equalizer 12. The serializer 11 is configured to convert the input parallel signal into a serial signal. For example, the serializer 11 can sequentially output the parallel signal D_{TX}[N-1:0] as multiple consecutive data according to the clock signal. The TX clock generator 13 can be a phase-locked loop (PLL), which generates the clock signal based on a reference clock.

The output of the serializer 11 is processed by the TX equalizer 12 and then outputted to the communication channel 2, so as to provide pre-equalization to the signal to compensate for (e.g., cancel out) the unintended distortions on signal. The TX equalizer 12 can include, for example, a finite impulse response (FIR) equalizer or a feedforward equalizer (FFE), etc.

The signal transmitted from the transmitting device 1 through the communication channel 2 to the receiving device 3 can be a multi-level PAM (pulse amplitude modulation) signal, such as a four-level PAM (PAM4) signal.

The receiving device 3 includes an equalizer 32, a demapper 33, a deserializer 34, and a receiving side (RX) clock generator 35. The signal received by the receiving device 3 from the communication channel 2 is processed by the equalizer 32, which is configured to encode the signal sample of multi-level PAM into an intermediate mapping symbol. The demapper 33 is configured to demap the intermediate mapping symbol and output a restored coding symbol. The LSB (least significant bit) of the intermediate mapping symbol represents the sign signal (Sgn), while at least one MSB (most significant bit) represents the absolute value of the signal amplitude. The deserializer 34 is configured to convert the input sequence signal into a parallel signal, which can be configured to deserialize the restored coding symbol. For example, the deserializer 34 can output the restored coding symbol as a parallel signal D_{RX}[N-1:0].

In some embodiments, the equalizer 32 may include multiple slicers, which are configured to encode the signal sample of multi-level PAM into the intermediate mapping symbol. The multiple slicers and the demapper 33 can be included in an equalizer module. For example, the equalizer 32 and the demapper 33 can be considered as a single equalizer module.

The RX clock generator 35, for example, is a clock data recovery (CDR) circuit. The RX clock generator 35 is coupled to the equalizer 32, the demapper 33, and the deserializer 34, and provides a clock signal to the equalizer 32, the demapper 33, and the deserializer 34.

The receiving device 3 may include an equalizer 31, such as a continuous time linear equalizer (CTLE). The signal received by the receiving device 3 from the communication channel 2 is first processed by the equalizer 31 and then by the equalizer 32. The equalizer 32, for example, is a decision feedback equalizer (DFE).

The multi-level PAM signal transmitted by the transmitting device 1 carries an original coding. The receiving device 3 must restore the received signal sample of multi-level PAM to obtain the data code matching the original coding, thereby obtaining the intended data codes transmitted by the transmitting device 1. The receiving device 3 does not restore the data code at a single stage in a manner directly matching the original coding. Instead, it utilizes a two-stage process. At first stage, the signal sample of multi-level PAM is encoded into the intermediate mapping symbol, of which the encoding does not match the original coding. Then at second stage, the intermediate mapping symbol is demapped to obtain the restored coding symbol, which are the exact data codes matching the original coding. Overall, the mapping encoding at the first stage and the demapping at the second stage match the original coding.

In some embodiments, the intermediate mapping symbol may behave like Gray code, which is beneficial to avoid signal transmission errors. In some embodiments, the above architecture and coding method can simplify the implementation of the DFE (e.g., equalizer 32) and the CDR circuit (RX clock generator 35). Additionally, in some embodiments, the decision making for the major transition (Mjr) only requires checking the absolute amplitude (power), which can reduce the circuit area by one-third for data decision making.

FIG. 2 shows a block diagram illustrating a DFE according to some embodiments. In FIG. 2, the equalizer 32 includes a data slicer 321, multiple delay units 322, and multiple feedback blocks 323. The output of the data slicer 321 is returned to the corresponding feedback block 323 at each tap point after passing through the delay unit 322. Each feedback block 323 corresponds to the output of the data slicer 321 that is delayed for different times.

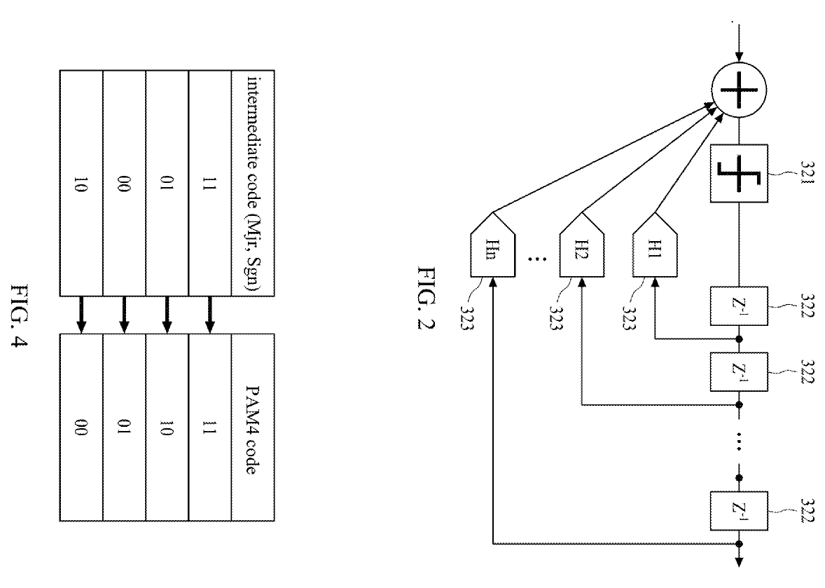

FIG. 3 shows a signal eye diagram illustrating the signal samples and encoding of a four-level PAM (PAM4) according to some embodiments. In FIG. 3, the PAM4 signal sample is encoded based on the sign and absolute value of the potential. The intermediate mapping symbol can be represented by (Mjr, Sgn). The LSB of the intermediate mapping symbol represents the sign, and its MSB represents the absolute value of the signal amplitude. The sign is determined based on the middle reference value. The sign is positive when the potential of the signal sample is greater than the middle reference value, so that the LSB of the intermediate mapping symbol is set to 1 (Sgn=1). The sign is negative when the potential of the signal sample is less than the middle reference value, so that the LSB of the intermediate mapping symbol is set to 0 (Sgn=0). The absolute value can be a quantized value, such as the quantized difference between the potential of the signal sample and the middle reference value. At least one bit of MSB of the intermediate mapping symbol represents the absolute value of the potential of the signal sample with respect to the middle reference value.

When viewed in the order from low to high potential, the intermediate mapping symbols generated are 10, 00, 01, and 11. For example, the intermediate mapping symbol is 11 when the potential of the signal sample is greater than a first threshold; the intermediate mapping symbol is 01 when the potential of the signal sample is greater than a second threshold but less than the first threshold; the intermediate mapping symbol is 00 when the potential of the signal sample is greater than the a threshold but less than the second threshold; and the intermediate mapping symbol is 10 when the potential of the signal sample is less than the third threshold. The second threshold can be the middle reference value, while the first and third thresholds are configured to generate a code representing the absolute value by quantization. The first, second, and third thresholds can correspond to the potentials DH, DZ, and DL in FIG. 3.

In some embodiments, multiple slicers can be used to process the signal sample of PAM4. For example, multiple slicers can be configured to encode the signal samples of multi-level PAM into an intermediate mapping symbol. These multiple slicers can include data slicers, error slicers, and crossing slicers. In FIG. 3, DH, DZ, and DL are the potentials referenced by the data slicer, while EHP, ELP, ELN, and EHN are the potentials referenced by the error slicer, and CH, CZ, and CL are the crossings referenced by the crossing slicer. Assuming vertical symmetry, then DH = - DL, EHP = -EHN, and ELP = -ELN (= h0). Assuming linearity, then DH = 2 * ELP (= 2 * h0), EHP = 3 * ELP (= 3 * h0), DL = 2 * ELN (=-2 * h0), and EHN = 3 * ELN (=-3 * h0).

In the case of PAM4 signal sample, only one bit changes between consecutive data codes. The encoding of the intermediate mapping symbol behaves like Gray code, which is beneficial to avoid signal transmission errors. This encoding manner also allows for a simpler implementation of the DFE (e.g., equalizer 32) and the CDR circuit (RX clock generator 35).

In the signal eye diagram shown in FIG. 3, if the traditional coding method for PAM4 signals is used instead, the data codes are generated based on the potential levels from low to high. For example, the data codes 00, 01, 10, 11 are generated based on the potential levels from low to high. However, this coding manner does not behave like Gray code.

In some embodiments, the encoding of the intermediate mapping symbol differs from the original coding applied for the multi-level PAM signals transmitted by the transmitting device 1. For example, the transmitting device 1 uses the above recited traditional coding for PAM4 signal to represent data code, while the encoding of the intermediate mapping symbol in the above embodiments is different.

FIG. 4 shows a table that illustrates the demapping table according to some embodiments. The demapping restores the intermediate mapping symbols to the data codes carried in the signal sample of multi-level PAM that were originally coded by the transmitting device 1. The demapping restores the intermediate mapping symbol to the data code represented by the traditional coding of multi-level PAM signals.

In FIG. 4, multi-level PAM is exemplified by PAM4. The demapping restores the intermediate mapping symbol to the data code represented by the traditional coding of PAM4 signals. For example, the output restored coding symbol is 11 when the intermediate mapping symbol is 11; the output restored coding symbol is 10 when the intermediate mapping symbol is 01; the output restored coding symbol is 01 when the intermediate mapping symbol is 00; and the output restored coding symbol is 00 when the intermediate mapping symbol is 10.

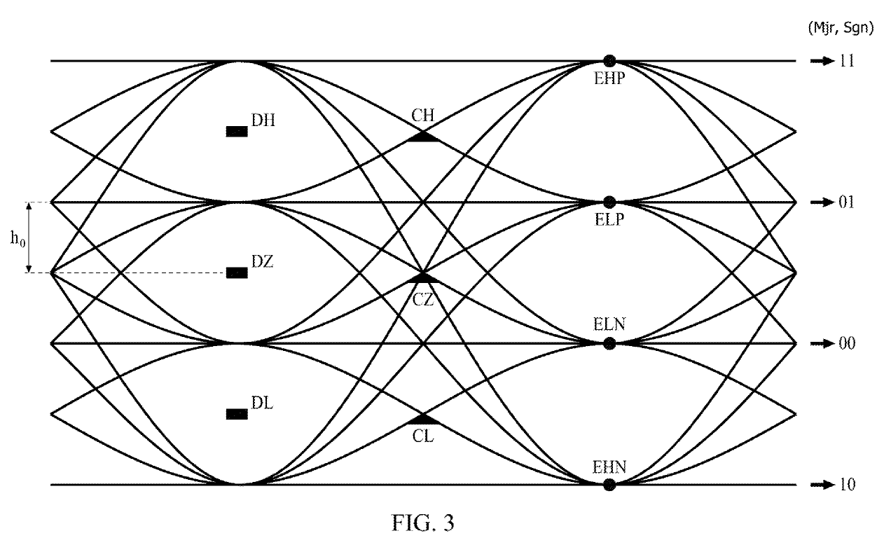

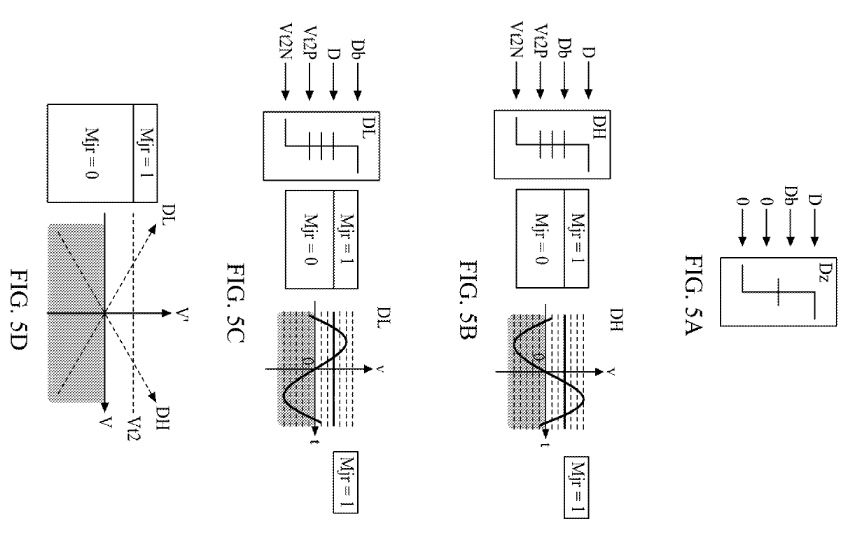

FIGS. 5A to 5C show schematic diagrams illustrating the decisions made by the data slicer according to some embodiments. In FIG. 5A, the potential DZ referenced by the data slicer is used for decision about sign (e.g. positive/negative), with vertical symmetrical decision intervals. In FIGS. 5B and 5C, the potentials DH and DL referenced by the data slicers are used for the decision of the absolute value of the signal amplitude. When the absolute value of the signal amplitude (or the absolute value of the signal potential) is greater, Mjr is set to 1; otherwise, it is set to 0. FIG. 5D shows a schematic diagram illustrating the potential mapping relation between reference to DL and reference to DH according to some embodiments, the horizontal axis V represents the voltage before mapping and the vertical axis V’ represents the voltage after mapping. In FIGS. 5B and 5D, the decision based on the absolute value of DH does not require a mapping of positive and negative signs or a mapping of positive and negative signs in the same direction; in FIGS. 5C and 5D, the decision about absolute value in accordance with DL requires a sign inversion mapping. After mapping, the decision about absolute value by reference to DL is made in the same way as DH. For example, Mjr is set to 1 when the potential V’ is greater, and otherwise, it is set to 0. Since DH and DL only need to check the absolute amplitude (power) for the decision making of the major transition (Mjr), this manner can reduce the circuit area by one-third for data decision making.

In addition, the present disclosure provides a receiving device that includes: an equalizer configured to encode a signal sample of multi-level PAM into an intermediate mapping symbol, wherein the LSB of the intermediate mapping symbol represents a sign, and at least one MSB represents an absolute value of the signal amplitude; and a demapper configured to demap the intermediate mapping symbol to output a restored coding symbol. The detailed description of the receiving device can refer to the aforementioned embodiments, and thus is not repeated here.

Furthermore, the present disclosure provides a signal processing method that includes: encoding a signal sample of multi-level PAM into an intermediate mapping symbol, wherein the LSB of the intermediate mapping symbol represents a sign, and at least one MSB represents an absolute value of the signal amplitude; and demapping the intermediate mapping symbol to output a restored coding symbol. The detailed description of the signal processing method can refer to the aforementioned embodiments, and thus is not repeated here.

Additionally, the present disclosure provides an equalizer module that includes: a plurality of slicers configured to encode a signal sample of multi-level PAM into an intermediate mapping symbol, wherein the LSB of the intermediate mapping symbol represents a sign, and at least one (MSB) represents an absolute value of the signal amplitude; and a demapper configured to demap the intermediate mapping symbol to output a restored coding symbol. The detailed description of the equalizer module can refer to the aforementioned embodiments, and thus is not repeated here.

Without further elaboration, it is believed that one skilled in the art can, based on the above description, utilize the present disclosure to its fullest extent. The specific embodiments are, therefore, to be construed as merely illustrative, and not limitative of the remainder of the disclosure in any way whatsoever.

1. A receiving device, comprising:
an equalizer configured to encode a signal sample of multi-level PAM into an intermediate mapping symbol, wherein the LSB of the intermediate mapping symbol represents a sign, and at least one MSB of the intermediate mapping symbol represents an absolute value of the signal amplitude; and
a demapper configured to demap the intermediate mapping symbol to output a restored coding symbol.

2. The receiving device of claim 1, wherein the multi-level PAM is four-level PAM (PAM4).

3. The receiving device of claim 2, wherein:
the intermediate mapping symbol is 11 when the potential of the signal sample is greater than a first threshold;
the intermediate mapping symbol is 01 when the potential of the signal sample is greater than a second threshold and less than the first threshold;
the intermediate mapping symbol is 00 when the potential of the signal sample is greater than a third threshold and less than the second threshold; and
the intermediate mapping symbol is 10 when the potential of the signal sample is less than the third threshold.

4. The receiving device of claim 2, wherein the demapping performed by the demapper comprises:
outputting the restored coding symbol as 11 when the intermediate mapping symbol is 11;
outputting the restored coding symbol as 10 when the intermediate mapping symbol is 01;
outputting the restored coding symbol as 01 when the intermediate mapping symbol is 00; and
outputting the restored coding symbol as 00 when the intermediate mapping symbol is 10.

5. The receiving device of claim 1, wherein:
the LSB of the intermediate mapping symbol is 1 when the potential of the signal sample is greater than a middle reference value; and
the LSB of the intermediate mapping symbol is 0 when the potential of the signal sample is less than the middle reference value.

6. The receiving device of claim 5, wherein the at least one MSB of the intermediate mapping symbol represents the absolute value of the potential of the signal sample with respect to the middle reference value, or at least one bit of MSB of the intermediate mapping symbol represents the absolute value of the potential difference between the signal sample and the middle reference value.

7. The receiving device of claim 1, wherein the equalizer is a decision feedback equalizer (DFE), and the receiving device further includes:
a continuous time linear equalizer (CTLE) coupled to the DFE;
a deserializer configured to deserialize the restored coding symbol; and
a clock data recovery circuit coupled to the DFE, the demapper, and the deserializer.

8. An equalizer module, comprising:
a plurality of slicers configured to encode a signal sample of multi-level PAM as an intermediate mapping symbol, wherein the LSB of the intermediate mapping symbol represents a sign, and at least one MSB represents an absolute value of the signal amplitude; and
a demapper configured to demap the intermediate mapping symbol to output a restored coding symbol.

9. The equalizer module of claim 8, wherein the multi-level PAM is four-level PAM (PAM4).

10. The equalizer module of claim 9, wherein:
the intermediate mapping symbol is 11 when the potential of the signal sample is greater than a first threshold;
the intermediate mapping symbol is 01 when the potential of the signal sample is greater than a second threshold and less than the first threshold;
the intermediate mapping symbol is 00 when the potential of the signal sample is greater than a third threshold and less than the second threshold; and
the intermediate mapping symbol is 10 when the potential of the signal sample is less than the third threshold.

11. The equalizer module of claim 9, wherein the demapping performed by the demapper comprises:
outputting the restored coding symbol as 11 when the intermediate mapping symbol is 11;
outputting the restored coding symbol as 10 when the intermediate mapping symbol is 01;
outputting the restored coding symbol as 01 when the intermediate mapping symbol is 00; and
outputting the restored coding symbol as 00 when the intermediate mapping symbol is 10.

12. The equalizer module of claim 8, wherein:
the LSB of the intermediate mapping symbol is 1 when the potential of the signal sample is greater than a middle reference value; and
the LSB of the intermediate mapping symbol is 0 when the potential of the signal sample is less than the middle reference value.

13. The equalizer module of claim 12, wherein the at least one MSB of the intermediate mapping symbol represents the absolute value of the potential of the signal sample with respect to the middle reference value.

14. A signal processing method, comprising:
encoding a signal sample of multi-level PAM as an intermediate mapping symbol, where the LSB of the intermediate mapping symbol represents a sign, and the at least one MSB represents an absolute value of the signal amplitude; and
demapping the intermediate mapping symbol to output a restored coding symbol.

15. The method of claim 14, wherein the multi-level PAM is four-level PAM (PAM4).

16. The method of claim 15, wherein:
the intermediate mapping symbol is 11 when the potential of the signal sample is greater than a first threshold;
the intermediate mapping symbol is 01 when the potential of the signal sample is greater than a second threshold and less than the first threshold;
the intermediate mapping symbol is 00 when the potential of the signal sample is greater than a third threshold and less than the second threshold; and
the intermediate mapping symbol is 10 when the potential of the signal sample is less than the third threshold.

17. The method of claim 15, wherein the demapping comprises:
outputting the restored coding symbol as 11 when the intermediate mapping symbol is 11;
outputting the restored coding symbol as 10 when the intermediate mapping symbol is 01;
outputting the restored coding symbol as 01 when the intermediate mapping symbol is 00; and
outputting the restored coding symbol as 00 when the intermediate mapping symbol is 10.

18. The method of claim 14, wherein:
the LSB of the intermediate mapping symbol is 1 when the potential of the signal sample is greater than a middle reference value; and
the LSB of the intermediate mapping symbol is 0 when the potential of the signal sample is less than the middle reference value.

19. The method of claim 18, wherein the at least one MSB of the intermediate mapping symbol represents the absolute value of the potential of the signal sample with respect to the middle reference value.

20. The method of claim 14, wherein the encoding is performed using a decision feedback equalizer (DFE), and the method further comprises:
using a continuous time linear equalizer (CTLE) on the signal samples of the multi-level PAM; and
deserializing the restored coding symbol.
